(19) United States
(12) Patent Application Publication
(10) Pub. No.: US 2021/0138470 A1
(43) Pub. Date: May 13, 2021

(54) FLUID DISPENSER

(71) Applicant: HEWLETT-PACKARD DEVELOPMENT COMPANY, L.P., Spring, TX (US)

(72) Inventors: Viktor Shkolnikov, Palo Alto, CA (US); Michael W. Cumbie, Corvallis, OR (US); Jeffrey A. Nielsen, Corvallis, OR (US)

(21) Appl. No.: 16/605,187

(22) PCT Filed: Oct. 24, 2017
(86) PCT No.: PCT/US2017/058070

§ 371 Date: Oct. 14, 2019

(51) Int. Cl. B01L 3/00

(52) U.S. Cl. CPC B01L 3/523; B01L 3/502715; B01L 2300/1827; B01L 2300/0896; B01L 2300/161; B01L 2400/0406

(57) ABSTRACT

A fluid dispenser may include a fluid ejector to eject fluid in a direction and a capillary pick up to wick fluid to the fluid ejector with capillary action. The capillary pick up may project beyond the fluid ejector in the direction.

### BACKGROUND

Many applications, such as those in microbiology, involve the selective dispensing of distinct volumes of fluid. Such selective dispensing is often manually performed using a pipette. In some circumstances, robotic pipetting devices are utilized.

### BRIEF DESCRIPTION OF THE DRAWINGS

FIG. 1 is a schematic diagram of an example fluid dispenser.

FIG. 2 is a flow diagram of an example method for dispensing fluid with a fluid dispenser.

FIG. 3 is a schematic diagram of an example fluid dispenser.

FIG. 4 is a flow diagram of an example method for dispensing fluid with the fluid dispenser.

FIG. 5 is a sectional view of an example fluid dispenser while up taking fluid from an example reservoir.

FIG. 6 is a schematic diagram of an example fluid ejector for the illustrated fluid dispensers, such as a fluid dispenser of FIG. 5.

FIG. 7 is a sectional view of an example fluid dispensing system with portions shown schematically.

FIG. 8 is an enlarged perspective view of an example well plate of the system of FIG. 7.

FIG. 9 is a top view of an example dispensing platform of the system of FIG. 7.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed herein are example fluid dispensers and methods that facilitate the dispensing of small volumes of fluid in an automated fashion, that facilitate the automated loading of fluid samples for dispensing by a fluid ejector and that facilitate precise washing of small surfaces with small amounts of fluid. The example fluid dispensers and methods utilize a capillary pick up to automatically load fluid or fluid samples for dispensing by the fluid ejector that ejects fluid in response to electrical signals.

In some examples, the fluid ejector dispenses fluid in a direction, whereas a capillary pick up projects beyond the fluid ejector in the direction. As a result, the capillary pick up in the fluid ejector may operate in one dimension, facing in the same direction, when up taking fluid to be dispensed and when dispensing the fluid. In addition, the capillary pick up may be lowered into the fluid while the fluid ejector remains above the fluid, inhibiting the unintended adsorption of the fluid on external surfaces of the fluid ejector and reducing the unintended transfer of the fluid by such external surfaces.

In some examples, the capillary pick up wicks fluid through a tapering interior of the tube. In some examples, the tapering interior the tube leads to the fluid ejector so as to supply the fluid ejector with fluid through the use of capillary forces. The tapering interior of the tube may be easily cleaned and may more easily deliver fluid to the fluid ejector. In other examples, the capillary pick up may utilize a wicking fiber or other absorbent wicking material.

Disclosed is an example fluid dispenser that may comprise a fluid ejector to eject fluid in a direction and a capillary pick up to wick fluid to the fluid ejector with capillary action. The capillary pick up may project beyond the fluid ejector in the direction.

Disclosed is an example fluid dispenser that may comprise a microfluidic die comprising a fluid ejector to eject fluid and a capillary pick up tube to wick fluid to the fluid ejector with capillary action. The capillary pick up tube may comprise a mouth with a diameter of less than or equal to 3 mm and an interior that tapers from the mouth to the microfluidic die.

Disclosed is an example method that may comprise wicking fluid through a tapering interior of a tube to the fluid ejector of a fluid dispenser. The method may further comprise selectively dispensing the fluid with the fluid ejector.

As will be appreciated, examples provided herein may be formed by performing various microfabrication and/or micromachining processes on a substrate to form and/or connect structures and/or components. The substrate may comprise a silicon based wafer or other such similar materials used for microfabricated devices (e.g., glass, gallium arsenide, plastics, etc.). Examples may comprise microfluidic channels, fluid actuators, and/or volumetric chambers. Microfluidic channels and/or chambers may be formed by performing etching, microfabrication processes (e.g., photolithography), or micromachining processes in a substrate. Accordingly, microfluidic channels and/or chambers may be defined by surfaces fabricated in the substrate of a microfluidic device. In some implementations, microfluidic channels and/or chambers may be formed by an overall package, wherein multiple connected package components that combine to form or define the microfluidic channel and/or chamber.

In some examples described herein, at least one dimension of a microfluidic channel and/or capillary chamber may be of sufficiently small size (e.g., of nanometer sized scale, micrometer sized scale, millimeter sized scale, etc.) to facilitate pumping of small volumes of fluid (e.g., picoliter scale, nanoliter scale, microliter scale, milliliter scale, etc.). For example, some microfluidic channels may facilitate capillary pumping due to capillary force. In addition, examples may couple at least two microfluidic channels to a microfluidic output channel via a fluid junction. At least one fluid actuator may be disposed in each of the at least two microfluidic channels, and the fluid actuators may be selectively actuated to thereby pump fluid into the microfluidic output channel.

The microfluidic channels may facilitate conveyance of different fluids (e.g., liquids having different chemical compounds, different physical properties, different concentrations, etc.) to the microfluidic output channel. In some examples, fluids may have at least one different fluid characteristic, such as vapor pressure, temperature, viscosity, density, contact angle on channel walls, surface tension, and/or heat of vaporization. It will be appreciated that examples disclosed herein may facilitate manipulation of small volumes of liquids.

A fluid actuator, may be implemented as part of a fluid ejector described herein may include, for example, thermal actuators, piezo-membrane based actuators, electrostatic membrane actuators, mechanical/impact driven membrane actuators, magnetostrictive drive actuators, electrochemical actuators, other such microdevices, or any combination thereof. In some examples, fluid actuators may be formed in microfluidic channels by performing various microfabrication processes.

FIG. 1 schematically illustrates portions of an example fluid dispenser 20. Fluid dispenser 20 facilitates the dispensing of small volumes of fluid in an automated fashion, facilitates the automated loading of fluid samples for dispensing by a fluid ejector and that facilitate precise washing of small surfaces with small amounts of fluid. Fluid dispenser 20 utilizes a capillary pick up to automatically load fluid or fluid samples for dispensing by the fluid ejector. Fluid dispenser 20 comprises fluid ejector (FE) 30 and capillary pick up (CP) 40.

Fluid ejector 30 comprises a device to selectively eject or dispense fluid. In the example, fluid ejector 30 is to eject fluid in the direction indicated by arrow 42. In one implementation, fluid ejector 30 comprises a chamber which receives fluid from the capillary pick up 40, a nozzle or orifice opening extending from the chamber and a fluid actuator adjacent the chamber so as to displace fluid within the chamber through the nozzle or orifice opening. In such an implementation, the nozzle or orifice opening faces in the direction of arrow 42.

The fluid actuator that displaces fluid within the chamber through the nozzle or orifice opening may comprise one of a variety of different fluid actuators. For example, the fluid actuator may comprise thermal actuators, piezo-membrane based actuators, electrostatic membrane actuators, mechanical/impact driven membrane actuators, magnetostrictive drive actuators, electrochemical actuators, other such microdevices, or any combination thereof. To provide the controlled ejection of small precise volumes of fluid, the fluid ejector 30 may comprise a fluid actuator in the form of a thermal actuator provided by an electrical resistor that outputs a sufficient amount of heat so as to nucleate or vaporize fluid within the chamber to create an expanding bubble that displaces fluid through the nozzle.

In one implementation, fluid ejector 30 is to controllably eject small volumes of fluid at a time or with a single ejection. For example, in one implementation fluid ejector 30 may eject a droplet of fluid having a volume of less than 1 nL. In one implementation, fluid ejector 30 may eject a droplet of fluid having a volume of less than 500 pL. In some implementations, fluid ejector 30 may eject a droplet of fluid having volume of less than or equal to 2 pL. For example, in implementations where fluid ejector 30 comprises a thermal actuator utilizing a thermal resistor to nucleate fluid and create an expanding bubble to displace fluid through a nozzle, the fluid ejector 30 may eject a droplet of fluid having a volume of less than or equal to 500 pL, and in some implementations, less than or equal to 2 pL (picoliters).

Capillary pick up 40 comprises a fluid wicking conduit that draws fluid in the direction indicated by arrow 44 using wicking or capillary action. Capillary action refers to the flowing of liquid in narrow spaces without the assistance of or in opposition to external forces such as gravity. Such capillary action or wicking may be the result of intermolecular forces between the liquid and the surrounding solid surfaces. In one implementation, capillary pick up 40 wicks or draws fluid through capillary action from mouth 46 all the way to fluid ejector 30. For example, in one implementation, capillary pick up 40 draws or wicks fluid through capillary action from mouth 46 all away to the above described chamber extending between and orifice and a fluid actuator.

In addition to drawing fluid and supplying fluid to fluid ejector 30, capillary pick up 40 may additionally serve as a storage volume or reservoir for fluid ejector 30. In one implementation, capillary pick up 40 stores the drawn up or wicked fluid until the fluid ejector ejects such fluid. As the fluid ejector 30 ejects fluid, capillary pick up 40 automatically replenishes the ejected fluid through capillary action, readying fluid ejector 30 for subsequent fluid ejection. In one implementation, fluid ejector 30 ejects a volume of fluid during a single ejection, wherein capillary pick up 40 contains and holds a multiple of the volume. For example, in one implementation, fluid ejector 30 may eject a volume a less than or equal to 1 nL, whereas capillary pick up 40 may store a volume of the fluid of at least 5 nL, supplying fluid for at least five fluid ejections with a single fluid pick up or dipping. In another implementation, capillary pick up 40 may contain or hold at least 10 nL following a single fluid pick up or dipping, supplying fluid for at least 10 fluid ejections.

In one implementation, capillary pick up 40 comprises a mass of a wicking fiber, grid, matrix or the like that wicks fluid in the direction indicated by arrow 44 using capillary action. In another implementation, capillary pick up 40 may comprise a hollow tube having a tapering interior that has a reduced cross-sectional area as it extends away from the mouth 46 of the tube. In some implementations, interior surfaces of the hollow tube forming capillary pick up 40 may be additionally coated with or formed from a fluid philic material. In some implementations, surfaces of mouth 46 may be formed from or coated with a fluid phobic material to inhibit adsorption of the fluid along the lip or mouth 46 where the fluid may be accidentally dislodged and accidentally released onto unintended surfaces.

As shown by FIG. 1, capillary pick up 40 and fluid ejector 30 are coupled to one another, directly or indirectly so as to be fixed relative to one another. In the example illustrated, fluid ejector 30 and capillary pick up 40 are coupled and retained relative to one another by an intermediate supporting or connecting structure 29. In one implementation, structure 29 carries an actuator or is coupled to an actuator so as to move fluid ejector 30 and capillary pick up 40 in unison with one another. As a result, capillary pick up 40 and fluid ejector 30 may be efficiently and precisely moved together between fluid reservoirs from which capillary pick up 40 draws fluid and fluid dispensing locations at which fluid ejector 30 dispenses the fluid supplied by capillary pick up 40.

In other implementations, capillary pick up 40 and fluid ejector 30 are fixed relative to one another, but are stationary, wherein the fluid reservoirs from which capillary pick up 40 draws fluid in the fluid dispensing locations at which fluid ejector 30 dispenses a fluid are moved relative to fluid ejector 30 and capillary pick up 40. In some implementations, capillary pick up 40 and fluid ejector 30 are coupled to one another so as to move in unison with one another while the fluid reservoir from which capillary pick up 40 draws fluid and the dispensing locations at which fluid ejector 30 dispenses the fluid also move relative to ejector 30 and pick up 40.

As further shown by FIG. 1, capillary pick up 40 projects in the same direction (direction 42) as a fluid ejector 30. As a result, the capillary pick up 40 and the fluid ejector 30 may operate in one dimension, facing in the same direction, when up taking fluid to be dispensed and when dispensing the fluid.

In addition, capillary pick up 40 projects beyond fluid ejector 30 in the direction indicated by arrow 42. This facilitates the dipping of mouth 46 into a reservoir 47 containing fluid 48 and below the level 49 of the fluid 48 without the lower surface 51 of fluid ejector 30 also being submersed or being brought into contact with fluid 48 even though reservoir 47 may be extending below fluid ejector 30 as capillary pick up 40 is being lowered into reservoir 47. As a result, the capillary pick up 40 may be lowered into the fluid while the fluid ejector 30 remains above the fluid, inhibiting the unintended adsorption of the fluid on external surfaces of the fluid ejector 30 and reducing the unintended transfer of the fluid by such external surfaces.

FIG. 2 is a flow diagram of an example method 100 for loading and dispensing a fluid. Method 100 facilitates the dispensing of small volumes of fluid in an automated fashion, that facilitate the automated loading of fluid samples for dispensing by a fluid ejector and that facilitate precise washing of small surfaces with small amounts of fluid. Method 100 utilizes a capillary pick up to automatically load fluid or fluid samples for dispensing by a fluid ejector that ejects fluid in an automated fashion in response to electrical signals. Although method 100 is illustrated as being carried out by fluid dispenser 20, it should be appreciative that method 100 may likewise be carried out with the other example fluid dispensers described hereafter or with similar fluid dispensers.

As indicated by block 104, fluid, such as fluid 48, is wicked from a mouth to a fluid ejector 30 through capillary pick up 40 which projects in a direction beyond fluid ejector 30 of fluid dispenser 20. The fluid is drawn from a reservoir and moved to fluid ejector 30 through capillary action. In one implementation, no additional assistance, such as additional pumping, is utilized to move the fluid to fluid ejector 30. Because capillary pick up 40 projects beyond fluid ejector 30 in the direction that fluid ejector 30 dispenses fluid, the capillary pickup 40 and the fluid ejector 30 may operate in a single dimension or group of parallel planes while reducing the occurrence of the fluid being accidentally coated upon lower surface of the fluid ejector 30.

As indicated by block 108, fluid ejector 30 selectively dispenses the fluid. In one implementation, the interior of capillary pick up 40 stores and holds fluid as fluid ejector 30 consumes the supply of fluid within the tapering interior. In one implementation, the interior of capillary pick up 40 stores a volume of fluid from a single fluid pick up, dipping or wicking sufficient to supply multiple individual fluid ejections or droplets of fluid ejector 30. In one implementation, fluid ejector 30 may eject a volume a less than or equal to 1 nL, whereas capillary pick up 40 may store a volume of the fluid of at least 5 nL, supplying fluid for at least five fluid ejections with a single fluid pick up or dipping. In another implementation, capillary pick up 40 may contain or hold at least 10 nL following a single fluid pick up or dipping, supplying fluid for at least 10 fluid ejections. As the size or volume of the drops ejected by ejector 30 decrease, the number of individual fluid ejections supplied with fluid from a single fluid pick up by capillary pickup 240 increases.

FIG. 3 schematically illustrates portions of an example fluid dispenser 220. Fluid dispenser 220 is similar to fluid dispenser 20 described above except that fluid dispenser 220 is specifically illustrated as comprising capillary pick up 240 in place of capillary pick up 40. Those remaining components of fluid dispenser 220 which correspond to components of fluid dispenser 20 are numbered similarly.

Similar to capillary pick up 40, capillary pick up 240 and fluid ejector 30 are coupled to one another, directly or indirectly, so as to move in unison with one another. As a result, capillary pick up 240 and fluid ejector 30 may be efficiently and precisely move together between fluid reservoirs from which capillary pick up 40 draws fluid and fluid dispensing locations at which fluid ejector 30 dispenses the fluid supplied by capillary pick up 40. Capillary pick up 240 projects beyond the lower face or surface 51 of fluid ejector 30 in the direction indicated by arrow 42, the same direction which fluid is ejected by fluid ejector 30. As a result, the capillary pick up 240 and the fluid ejector 30 may operate in one dimension, facing in the same direction, when up taking fluid to be dispensed and when dispensing the fluid. In addition, the capillary pick up 240 may be lowered into the fluid while the fluid ejector 30 remains above the fluid, inhibiting the unintended adsorption of the fluid on external surfaces of the fluid ejector, such as surface 51, and reducing the unintended transfer of the fluid by such external surfaces.

As further shown by FIG. 3, capillary pick up 240 comprises a tube having an interior tapering passage 250. The tapering interior profile of passage 250 facilitates the wicking of fluid through capillary action in the direction indicated by arrow 44. Because passage 250 utilizes a tapering profile to facilitate wicking, passage 250 is clear or open, reducing the likelihood of clogging or occlusion due to the drying of particles. Passage 250 is also more easily cleaned.

In one implementation, the tapering interior 250 of the tube forming capillary pickup 240 extends from mouth 246 all the way to fluid ejector 30. As a result, fluid is moved all the way from mouth 246 to fluid ejector 30 with capillary action without additional pumps.

In one implementation, the tapering interior 250 has interior surfaces formed from a material that is completely wetted with the fluid being drawn up. In other words, the tapering interior 250 has surfaces formed from a material that is fluid philic with respect to the fluid that is being drawn up. In one implementation, the surface of the tapering interior 250 comprises a material such as polyetherimide (PEI). In some implementations, the surfaces of the tapering interior 250 may be formed by an over molded material. For example, in some implementations, the tube forming capillary pick up 240 may be formed from a first material, wherein the interior surfaces of the tapering interior 250 or formed from a second different material, coated upon the first material. In some implementations, the interior surfaces may be coated with a metal such as gold. In one implementation, the tube or tip forming capillary pick up 240 may be fabricated out of an injectable moldable plastic, wherein a layer of metal (hydrophilic relative to plastic such as polypropylene) is electrolessly plated over the plastic. In some implementations, the interior surface of tapering interior 250 may be formed from other less hydrophilic materials such as polypropylene.

The mouth 246 of the tube forming capillary pick up 240 has a diameter of less than or equal to the capillary length of the fluid to be drawn up through capillary action. In one implementation, capillary pick up 240 has a diameter of less than or equal to 6 mm (based upon the capillary length of water). This dimension also facilitates the withdrawal of fluid by capillary pick up 240 from small reservoirs having small openings or ports.

In other implementations, the diameter of mouth 246 of the tube capillary pick 240 is one that provides for capillary rise (pursuant to Jurin's law) within and along the tube of capillary pick up 240, from mouth 246 completely to fluid ejector 30. In other implementations, mouth 246 may be larger where pumps may be utilized to draw fluid from reservoir 47 or to assist the flow of the fluid, initially drawn up through capillary forces, to fluid ejector 30.

In addition to drawing fluid and supplying fluid to fluid ejector 30, capillary pick up 240 may additionally serve as a storage volume or reservoir for fluid ejector 30. In one implementation, capillary pick up 240 stores the drawn up or whipped fluid until fluid ejector that ejects such fluid. As a fluid ejector 30 ejects fluid, capillary pick up 240 replenishes the ejected fluid, readying fluid ejector 30 for subsequent fluid ejection. In one implementation, fluid ejector 30 ejects a volume of fluid during a single ejection, wherein capillary pick up 240 contains and holds a multiple of the volume. For example, in one implementation, fluid ejector 30 may eject a volume a less than or equal to 1 nL, whereas capillary pick up 240 may store a volume of the fluid of at least 5 nL, supplying fluid for at least five fluid ejections with a single fluid pick up or dipping. In another implementation, capillary pick up 240 may contain or hold at least 10 nL following a single fluid pick up or dipping, supplying fluid for at least 10 fluid ejections. As the size or volume of the drops ejected by ejector 30 decrease, the number of individual fluid ejections supplied with fluid from a single fluid pick up by capillary pickup 240 increases.

FIG. 4 is a flow diagram of an example method 300 for loading and dispensing a fluid. Method 300 facilitates the dispensing of small volumes of fluid in an automated fashion, that facilitate the automated loading of fluid samples for dispensing by a fluid ejector and that facilitate precise washing of small surfaces with small amounts of fluid. Method 300 utilizes a capillary pick up to automatically load fluid or fluid samples for dispensing by a fluid ejector that ejects fluid in an automated fashion in response to electrical signals. Although method 300 is illustrated as being carried out by fluid dispenser 220, it should be appreciative that method 300 may likewise be carried out with the other example fluid dispensers described hereafter or with similar fluid dispensers.

As indicated by block 304, fluid, such as fluid 48, is wicked from a mouth to a fluid ejector through a tapering interior of a tube. The fluid is drawn from a reservoir and moved to fluid ejector 30 through capillary action. In one implementation, no additional assistance, such as additional pumping, is utilized to move the fluid to fluid ejector 30.

As indicated by block 308, fluid ejector 30 selectively dispense a fluid. In one implementation, the tapering interior of the tube stores and holds fluid as fluid ejector 30 consumes the supply of fluid within the tapering interior. In one implementation, the tapering interior the tube stores a volume of fluid from a single fluid pick up, dipping or wicking sufficient to supply multiple individual fluid ejections or droplets of fluid ejector 30. In one implementation, fluid ejector 30 may eject a volume a less than or equal to 1 nL, whereas capillary pick up 240 may store a volume of the fluid of at least 5 nL, supplying fluid for at least five fluid ejections with a single fluid pick up or dipping. In another implementation, capillary pick up 240 may contain or hold at least 10 nL following a single fluid pick up or dipping, supplying fluid for at least 10 fluid ejections. As the size or volume of the drops ejected by ejector 30 decrease, the number of individual fluid ejections supplied with fluid from a single fluid pick up by capillary pickup 240 increases.

FIG. 5 is a sectional view of an example fluid dispenser 420 during the withdrawal of fluid 48 from reservoir 47. Fluid dispenser 420 comprises support 429, fluid ejector 30 and capillary pick up 440. Support 429 comprises a structure that supports both fluid ejector 30 and capillary pickup 440. In the example illustrated, support 429 comprises an elongate member having a distal end supporting fluid ejector 30 and capillary pickup 440. In the example illustrated, support 429 comprises a member that tapers towards its distal end where fluid ejector 30 and capillary pick up 440 are located. The narrow tapering distal end of support 429 facilitates the positioning of capillary pickup 440 into a reservoir 47 having a limited sized mouth or opening.

In one implementation, support 429 additionally comprises a coupler 431 which facilitates removable or releasable mounting of support 429 to a positioner that controllably positions or moves support 429, the carried fluid ejector 30 and capillary pickup 440, relative to (A) a source of fluid for capillary pickup 440 and (B) a dispensing location for fluid ejector 30. In one implementation, coupler 431 comprises a snap which resiliently flexes to attach support 429 to a positioner. In another implementation, coupler 431 may comprise one of a tongue and groove that slides into the other of a tongue and groove of a positioner. In yet another implementation, coupler 431 may comprise a plug that is releasably received within a corresponding port of a positioner. In such implementations, coupler 431 may comprise electrical contact pads, electrical conductive pins or the like that facilitate the transmission of electrical power as well as electrical control signals from the positioner (or a controller) to fluid ejector 30 carried by dispenser 420 to power and control fluid ejector 30. In yet another implementation, coupler 431 may comprise a tapered barrel female that is to be compression fit into a corresponding tapered barrel male of the positioner. In other implementations, coupler 431 may be omitted, where support 429 is otherwise formed as part of a positioner or other supporting structure.

Fluid ejector 30 is described above. FIG. 6 schematically illustrates fluid ejector 530, one example of a fluid ejector that may be utilized as fluid ejector 30 in fluid dispensers 20, 220 or 420. Fluid ejector 530 comprises chamber 534, nozzle orifice 536 and fluid actuator 538. Chamber 534 comprises a volume to contain a fluid received from a capillary pickup, such as capillary pickup 40, 240 or 440. Nozzle orifice 536 comprise an opening extending from the interior of chamber 534 and through which fluid may be ejected in the direction 42. Fluid actuator 538 comprise a mechanism that displaces fluid within chamber 534 through orifice 536. In one implementation, fluid actuator 538 may comprise thermal actuators, piezo-membrane based actuators, electrostatic membrane actuators, mechanical/impact driven membrane actuators, magnetostrictive drive actuators, electrochemical actuators, other such microdevices, or any combination thereof. To provide the controlled ejection of small precise volumes of fluid, the fluid ejector 530 may comprise a fluid actuator 538 in the form of a thermal actuator provided by an electrical resistor that outputs a sufficient amount of heat so as to nucleate or vaporize fluid within the chamber 534 to create an expanding bubble that displaces fluid through the nozzle orifice 536.

As shown by FIG. 5, capillary pickup 440 is similar to capillary pick up 240 described above. Capillary pick up 440 projects beyond the lower face or surface 51 of fluid ejector 30 in the direction indicated by arrow 42, the same direction which fluid is ejected by fluid ejector 30. As a result, the capillary pick up 440 and the fluid ejector 30 may operate in one dimension, facing in the same direction, when up taking fluid to be dispensed and when dispensing the fluid. In addition, the capillary pick up 440 may be lowered into the fluid while the fluid ejector 30 remains above the fluid, inhibiting the unintended adsorption of the fluid on external surfaces of the fluid ejector, such as surface 51, and reducing the unintended transfer of the fluid by such external surfaces.

As further shown by FIG. 5, capillary pick up 440 comprises a tube having an interior tapering passage 450. The tapering interior profile of passage 450 facilitates the wicking of fluid through capillary action in the direction indicated by arrow 44. Because passage 450 utilizes a tapering profile to facilitate wicking, passage 450 is clear or open, reducing the likelihood of clogging or occlusion due to the drying of particles. Passage 450 is also more easily cleaned.

In one implementation, the tapering interior 450 the tube forming capillary pickup 440 extends from mouth 446 all the way to fluid ejector 30. As a result, fluid is moved all the way from mouth 446 to fluid ejector 30 with capillary action without additional pumps. In one implementation, the tapering interior 450 has surfaces that are formed from a material that is completely wetted with the fluid being drawn up. In other words, the tapering interior 450 has interior surfaces formed from at least one material that is fluid philic with respect to the fluid that is being drawn up. In one implementation, the surfaces of the tapering interior 450 comprise a material such as polyetherimide (PEI). In some implementations, the surfaces of the tapering interior 250 may be formed by an over molded material. For example, in some implementations, the tube forming capillary pick up 440 may be formed from a first material, wherein the interior surfaces of the tapering interior 450 or formed from a second different material, coated upon the first material. In some implementations, the interior surfaces may be coated with a metal such as gold. In one implementation, the tube or tip forming capillary pick up 440 may be fabricated out of an injectable moldable plastic, wherein a layer of metal (hydrophilic relative to plastic such as polypropylene) is electrolessly plated over the plastic. In another implementation, the entirety of capillary pickup 440 is formed from the fluid philic material, such as hydrophilic respect to water. In some implementations, the interior surface of tapering interior 450 may be formed from other less hydrophilic materials such as polypropylene.

The mouth 446 of the tube forming capillary pick up 440 has a diameter of less than or equal to the capillary length of the fluid to be drawn up through capillary action. In one implementation, capillary pick up 440 has a diameter of less than or equal to 6 mm (based upon the capillary length of water). This dimension also facilitates the withdrawal of fluid by capillary pick up 440 from small reservoirs having small openings or ports.

In other implementations, the diameter of mouth 446 of the tube capillary pick 440 is one that provide for capillary rise (pursuant to Jurin's law) within and along the tube of capillary pick up 440, from mouth 446 completely to fluid ejector 30. In other implementations, mouth 446 may be larger where pumps may be utilized to draw fluid from reservoir 47 or to assist the flow of the fluid, initially drawn up through capillary forces, to fluid ejector 30.

In addition to drawing fluid and supplying fluid to fluid ejector 30, capillary pick up 440 may additionally serve as a storage volume or reservoir for fluid ejector 30. In one implementation, capillary pick up 440 stores the drawn up or whipped fluid until fluid ejector that ejects such fluid. As a fluid ejector 30 ejects fluid, capillary pick up 440 replenishes the ejected fluid, readying fluid ejector 30 for subsequent fluid ejection. In one implementation, fluid ejector 30 ejects a volume of fluid during a single ejection, wherein capillary pick up 440 contains and holds a multiple of the volume. For example, in one implementation, fluid ejector 30 may eject a volume a less than or equal to 1 nL, whereas capillary pick up 440 may store a volume of the fluid of at least 5 nL, supplying fluid for at least five fluid ejections with a single fluid pick up or dipping. In another implementation, capillary pick up 440 may contain or hold at least 10 nL following a single fluid pick up or dipping, supplying fluid for at least 10 fluid ejections. As the size or volume of the drops ejected by ejector 30 decrease, the number of individual fluid ejections supplied with fluid from a single fluid pick up by capillary pickup 440 increases.

FIG. 7 schematically illustrates an example fluid dispensing system 500. Fluid dispensing system 500 comprises stage 502, supply/mixing well plate 504, dispensing platform 506, fluid dispensers 420, positioner 524, sensor 526 and controller 528. Stage 502 comprise a base that supports well plate 504 and dispensing platform 506. In one implementation stage 502 is stationary. In another implementation, stage 502 is movable in at least one axis or dimension. For example, in one implementation, stage 502 is movable in the X, Y and Z axes to controllably position well plate 504 and dispensing platform 506 relative to fluid dispensers 420.

Supply/mixing well plate 504 comprises a plurality of individual wells or cavities for containing various different fluids and/or samples. FIG. 8 is an enlarged sectional view illustrating an example of well plate 504. As shown by 8, well plate 604 may comprise a two-dimensional array of individual wells 560 which may be filled with various fluids or samples for being drawn up by fluid dispensers 420 and for being dispensed by fluid dispensers 420 upon dispensing platform 506. In one implementation, wells 560 may be supplied with fluid through fluid conduit disposed within stage 502. In another implementation, wells 560 may be supplied with fluid by external dispensers.

In one implementation, each of wells 502 comprises a floor region 562 and a top surface and rim or mouth region 564 which are coated with or formed from a hydro-phobic material. Both sidewalls of wells 502 between the floor 562 and the mouth 564 are formed from a hydrophilic material. In one implementation, each of wells 562 contains a volume that is multiple times the fluid holding capacity of each individual fluid pick up 440 of fluid dispensers 420. In one implementation, each of wells 562 retains at least 33 nL. In other implementations, the wells 560 may have other capacities.

In one implementation, wells 560 each have a mouth diameter of at least 3.5 mm. In one implementation come each of wells 560 have a mouth diameter of no greater than 16 mm. In one implementation, well plate 504 comprises 384 wells 560, each of wells 560 having a mouth 564 having a diameter of 3.5 mm with a 4.5 mm center to center spacing between the wells. In one implementation, well plate 504 comprises 96 wells 560, each of the wells 560 having a mouth 564 having a diameter of 7.5 mm with a center to center spacing between the wells of 9 mm. In another implementation, well plate 504 comprises 24 wells 560, each of the wells 560 having a mouth 564 having a diameter of 16 mm with a center to center spacing between the wells of 18 mm. In some implementations, some of wells 560 are empty, providing volumes for mixing different sample or fluid from other wells 560.

Dispensing platform 506 comprise a region where fluid is dispensed by dispensers 420 and where capillary pickup 440 may be cleaned or washed prior to withdrawing a different fluid from a different one of wells 560. FIG. 9 is a top view of an example of dispensing platform 506. As shown by FIGS. 7 and 9, dispensing platform 506 comprises cartridge 570, wiping pad 572, washing fluid reservoir 574 and waste reservoir 576.

Cartridge 570 comprises a microfluidic chip or die having ports into which fluid from fluid dispensers 420 may be ejected or dispensed. Cartridge 570 may include various microfluidic passages, microfluidic mechanisms or micro-electromechanical (MEM) devices that interact with the dispensed fluid. To this end, cartridge 570 may comprise various pumps, valves, sensors and the like. In one implementation, cartridge 570 is removably mounted upon platform 506. In another implementation, cartridge 570 may be formed as part of platform 506. In the example illustrated, cartridge 506 comprises ports 578 through which fluid may be ejected into cartridge 570 from fluid ejectors 30. In some implementations, fluid that has been interacted or sensed by cartridge 570 may be withdrawn from cartridge 570 through ports 578 using dispensers 420.

As further shown by FIG. 9, cartridge 570 comprises electrical contacts 580 that facilitate control of cartridge 570 in communication with cartridge 570. In one implementation, cartridge 570 may be electrically connected to controller 528 during the dispensing of fluid into or withdrawal of fluid from cartridge 570, providing closed loop feedback regarding the dispensing of fluid into cartridge 570 or the withdrawal of fluid from cartridge 570. Such communication may facilitate the control over the time at which fluid is dispensed into or withdrawn from cartridge 570. In other implementations, cartridge 570 may be inactive while fluid is dispensed into or withdrawn from cartridge 570, wherein the active components of cartridge 570 are powered and controlled when cartridge 570 is removed from stage 502.

Wiping pad 572 comprises a surface by which the mouth 446 of capillary pickup 440 (shown in FIG. 5) of each of fluid dispensers 420 may be wiped and cleaned. Washing fluid reservoir 574 comprises a reservoir containing a washing fluid 582 for removing or cleaning mouth 446 and the exterior of capillary pickup 440. The cleaning fluid contained within reservoir 574 may be drawn up by capillary pickup 440 and subsequently ejected by fluid ejector 30 into waste reservoir 576 to clean the interior of capillary pickup 440 and fluid ejector 30. Such cleaning may reduce cross-contamination amongst the different fluids in the different wells 560. In some implementations, wiping pad 572 and reservoirs 574, 576 may be omitted.

Fluid dispensers 420 are described above and illustrated in FIG. 5. In the example illustrated, fluid dispensers 420 are removably mounted to positioner 524. Although positioner 524 is illustrated as carrying three fluid dispensers 420, in other implementations, positioner 524 may carry or support a greater or fewer of such fluid dispensers 420. Each of fluid dispensers 420 are electrically connected to controller 528 by various wires or traces to facilitate control of fluid ejectors 30 of dispensers 420 by controller 528. Each of the fluid dispensers 420 has a distal end providing fluid ejector 30 and capillary pickup 440, wherein the distal end is sized to be dipped into each of wells 560 and to be dipped into reservoir 574. In implementations where dispensers 420 are to withdraw fluid from cartridge 570, the distal end of dispensers 420 may likewise be sized to be dipped into at least one of ports 578 of cartridge 570.

Positioner 524 comprises a positioning device that carries and controllably positions dispensers 420 relative to stage 502. In one implementation, positioner 524 comprises one or more belts, tracks, guides or the like which guide movement of a carriage which is driven by electrical motors, pneumatic cylinder-piston assemblies, electrical servos or the like. In one implementation, positioner 524 is to reposition each of dispensers 420 along each of the X, Y and Z axes.

Sensor 526 comprise at least one sensor to sense the relative positioning of positioner 524 with respect to stage 502. In one implementation, sensor 526 comprises an optical sensor. In other implementations, sensor 526 may comprise an electrical contact switch or other sensor. Signals from sensor 526 are communicated to controller 528.

Controller 528 comprises a device that outputs control signals controlling positioner 524 and fluid ejectors 30 of fluid dispensers 420. In some implementations, controller 528 may additionally control cartridge 570. Controller 528 comprises a processing unit that follows instructions contained in a non-transitory computer-readable medium or an integrated circuit having logic elements that provide such instructions, wherein the instructions direct controller 5282 output the control signals. In one implementation controller 528 outputs control signals to positioner 524 and fluid ejectors 30 of fluid dispensers 420 based upon signals received from sensor 526.

When operating according to one set of instructions and one example protocol, controller 528 may output control signals causing positioner 524 to position dispensers 420 relative to well plate 504 such that different fluid dispensers 420 to take-up fluid from different wells 560. Controller 528 may further output control signals causing positioner 524 to reposition such dispensers 420 having capillary pickup 440 filled with the respective fluids, opposite to empty wells 560, wherein control signals from controller 528 cause fluid ejectors 30 to eject or dispense precisely controlled volumes of the different fluids into the empty wells for mixing different fluids in the empty mixing wells. Thereafter, the mixed fluids may be withdrawn by capillary pickup 440 of at least one of the dispensers 420. Controller 528 may then output control signals causing positioner 524 to locate dispensers 420 opposite to selected ports 578 of cartridge 570, wherein controller 528 outputs control signals causing fluid ejectors 30 to eject the mixture of the fluids into the selected ports 578 of cartridge 570.

In some implementations, such mixing may be omitted or may be carried out in cartridge 570, wherein the fluid withdrawn from the selected wells 560 by capillary pickups 440 is directly transferred to cartridge 570. For example, after at least one of the fluid dispensers 520 has been loaded with at least one fluid from wells 560 such that the fluid is stored within capillary pickups 440, controller 528 may output control signals to positioner 524 causing positioner 524 to locate selected fluid dispensers 420 opposite to selected ports 578 of cartridge 570. Once the selected fluid dispensers 420 are in position opposite to the selected ports 578, controller 528 may output control signals causing the selected fluid ejectors 30 to eject the different selected fluids into selected ports 578 of cartridge 570.

In some implementations, rather than dispensing fluid into cartridge 570, system 500 may dispense small volumes of fluid onto other surfaces. For example, in other implementations, controller 528 may control positioner 524 and fluid ejectors 302 dispense precisely controlled volumes of fluids onto very small regions to be cleaned or otherwise treated. Overall, system 500 provides for automated pickup of fluid in the dispensing of precisely controlled small volumes of fluid at precise locations.

Although the present disclosure has been described with reference to example implementations, workers skilled in the art will recognize that changes may be made in form and detail without departing from the spirit and scope of the claimed subject matter. For example, although different example implementations may have been described as including one or more features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A fluid dispenser comprising:
a fluid ejector to eject fluid in a direction; and
a capillary pick up projecting beyond the fluid ejector in the direction.

2. The fluid dispenser of claim 1, wherein the capillary pick up comprises a tube having a tapering interior.

3. The fluid dispenser of claim 2, wherein the tube comprises a mouth, wherein the tapering interior tapers from the mouth to the fluid ejector.

4. The fluid dispenser of claim 3, wherein the tapering interior comprises a hydrophilic interior surface.

5. The fluid dispenser of claim 1, wherein the capillary pick up comprises a tube having a mouth with a diameter of less than or equal to twice a capillary length of fluid to be ejected by the fluid ejector.

6. The fluid dispenser of claim 1, wherein the capillary pick up comprises a tube having a mouth having a diameter of less than or equal to 6 mm.

7. The fluid dispenser of claim 1, wherein the fluid ejector comprises a microfluidic die having a fluid ejector that dispenses individual volumes of less than or equal to a nanoliter.

8. The fluid dispenser of claim 7, wherein the fluid ejector comprises a thermal resistor to nucleate adjacent fluid and form a bubble that ejects fluid through a nozzle.

9. The fluid dispenser of claim 1 further comprising a second fluid ejector to eject fluid in the direction, wherein the capillary pick up supplies fluid to the second fluid ejector.

10. The fluid dispenser of claim 1 further comprising:
a second fluid ejector to eject fluid in the direction; and
a second capillary pick up to wick fluid to the second fluid ejector with capillary action, the second capillary pick up projecting beyond the second actuator in the direction.

11. The fluid dispenser of claim 1 further comprising a second capillary pick up to wick fluid to the fluid ejector with capillary action, the second capillary pick up projecting beyond the fluid ejector in the direction.

12. The fluid dispenser of claim 1 comprising a capillary pick up cleaner selected from a group of cleaners consisting of: a wiping pad and a cleaning fluid reservoir.

13. A method for dispensing fluid with a fluid dispenser, the method comprising:
wicking fluid through a tapering interior of a tube to a fluid ejector of the fluid dispenser; and
selectively ejecting the fluid with the fluid ejector.

14. The method of claim 13, wherein the fluid is dispensed with individual volumes less than or equal to one nanoliter.

15. A fluid dispenser comprising:
a microfluidic die comprising a fluid ejector to eject fluid; and
a capillary pick up tube to wick fluid to the fluid ejector with capillary action, the capillary pick up tube comprising:
a mouth with a diameter of less than or equal to 3 mm; and
an interior that tapers from the mouth to the microfluidic die.
